(19) United States
(12) Patent Application Publication
(10) Pub. No.: US 2015/0213256 A1
(43) Pub. Date: Jul. 30, 2015

(54) KEY CONTROL METHOD AND ASSOCIATED ELECTRONIC DEVICE FOR DETERMINING WHETHER TO PERFORM KEY OPERATION CORRESPONDING TO KEY EVENT

(71) Applicant: MediaTek Singapore Pte. Ltd., Singapore (SG)

(72) Inventor: Qi Wang, Baotou City (CN)

(21) Appl. No.: 14/608,142

(22) Filed: Jan. 28, 2015

(30) Foreign Application Priority Data
Jan. 29, 2014 (CN) 201410043774.2

(51) Int. Cl. G06F 21/44

(52) U.S. Cl. CPC G06F 21/44

(57) ABSTRACT

A key control method of an electronic device includes: receiving a key event; obtaining current key locking information of the electronic device from a system frame module of the electronic device; and determining whether to perform a key operation corresponding to the key event according to the key event and the current key locking information.

### BACKGROUND

The present invention relates to controlling keys, and more particularly, to a key control method and an associated electronic device capable of determining whether to perform a key operation corresponding to a key event.

The popularity of wireless communication devices such as mobile phones has been adapted for use in work, study and entertainment arenas. When a user operates a smart phone, to play a game, for example, physical keys or virtual keys thereof might be touched by accident, resulting in the game being paused or interrupted, which spoils the experience of the user. Some applications (APPs) have been developed to lock virtual keys such as “home” and “back”, wherein specific window flags in the application layer of a wireless communication device are set to intercept certain key events, but some side effects may be introduced as a consequence. For example, normal key events intentionally inputted by a user might be determined as undesired and thereby be intercepted.

Hence, for wireless communication devices, how to self-define keys which need to be locked and correctly intercept locked key operations has become an important issue in the field.

### SUMMARY

One of the objectives of the present invention is to provide a key control method and an electronic device to solve the above issue.

One aspect of the invention discloses a key control method for an electronic device. The key control method comprises: receiving a key event; obtaining current key locking information of the electronic device from a system frame module of the electronic device; and determining whether to perform a key operation corresponding to the key event according to the key event and the current key locking information.

Another aspect of the invention discloses a further key control method for an electronic device. The key control method comprises: receiving a key signal; obtaining current key locking information of the electronic device from a hardware driving module of the electronic device; and determining whether to intercept the key signal according to the key signal and the current key locking information.

Yet another aspect of the invention discloses an electronic device. The electronic device comprises: a hardware driving module and a system frame module. The hardware driving module is arranged for sending a key event. The system frame module is arranged to receive the key event from the hardware driving module, store current key locking information of the electronic device, and determine whether to perform a key operation corresponding to the key event.

Still another aspect of the invention discloses a further electronic device. The electronic device comprises a user interface and a hardware driving module. The user interface is arranged to generate a key signal. The hardware driving module is arranged to receive the key signal, store current key locking information of the electronic device, and determine whether to intercept the key signal according to the key signal and the current key locking information.

Through utilizing the key control methods and the electronic devices provided by the preset invention, the purpose of correctly intercepting operations performed upon the locked keys can be achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device arranged for performing a key control method according to an embodiment of the present invention.

FIG. 2 is a flowchart illustrating a method of using a system frame module to control keys according to an embodiment of the present invention.

FIG. 3 is a flowchart illustrating a method of selecting keys which need to be locked according to an embodiment of the present invention.

FIG. 4 is a flowchart illustrating a method of using a hardware driving module to intercept keys according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

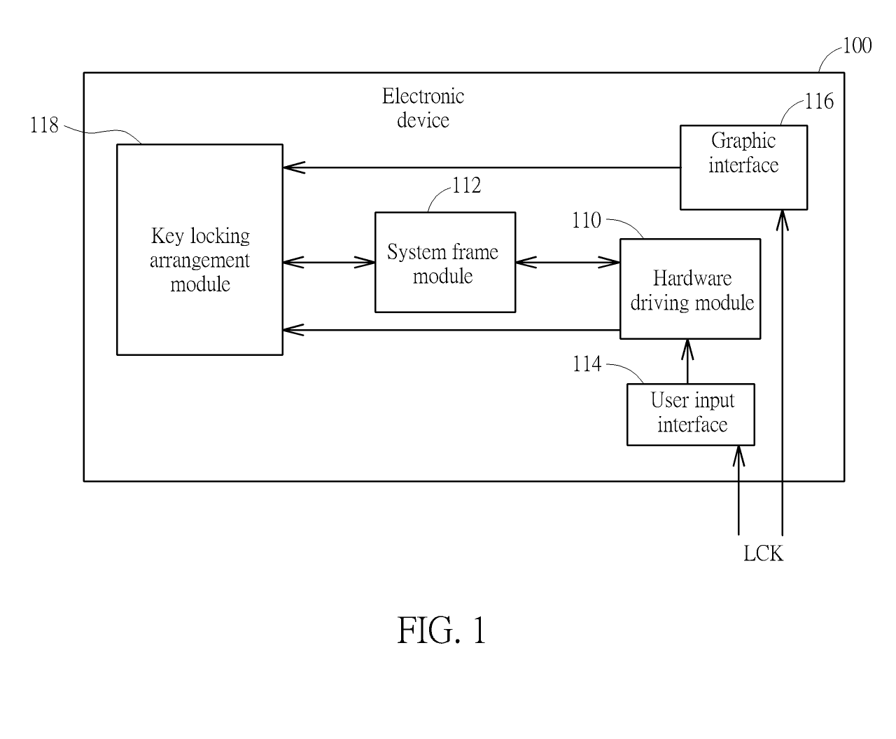

Please refer to FIG. 1, which is a schematic diagram illustrating an electronic device 100 arranged for performing a key control method according to an embodiment of the present invention. In FIG. 1, the electronic device 100 (e.g. mobile phone, tablet, personal digital assistant (PDA), vehicle positioning device, etc.) includes a hardware driving module 110, a system frame module 112 and a user input interface 114. The hardware driving module 110 is arranged to receive a key signal from the user input interface 114, and then convert the received key signal into a corresponding key event which is sent to the system frame module 112. The user input interface 114 may be a physical key board, a virtual keyboard, physical keys, or virtual keys, etc. The key signal is an electric signal formed due to a key (e.g. a physical key or a virtual key) being operated (e.g. clicked or touched) by a user through the user input interface 114.

The system frame module 112 receives the key event sent by the hardware driving module 110, and then converts the received key event into the key code CODE1, wherein the key code CODE1 corresponds to a physical or virtual key of the electronic device 100. For example, if the user clicks a “home” key at the user input interface 114, the hardware driving module 110 converts this click operation into a key event, and then transmits the key event to the system frame module 112. After receiving the key event, the system frame module 112 converts the key event into the corresponding key code CODE1. For example, the number “3” corresponds to the “home” key of the main window (i.e. KEYCODE HOME=3, wherein all key codes illustrated in the present invention are decimal, but the present invention is not limited thereto).

In the present embodiment, the system frame module 112 further stores key locking information. The key locking information indicates the current key locking state of the electronic device 100, e.g. indicates that the keys “home” and “back” among the keys “home,” “back” and “search” of the electronic device 100 have been locked. In an embodiment, the key locking information includes at least one key code CODE2. The key code CODE2 indicates that one or more keys of the electronic device 100 have been locked. For example, indicating that the keys “home” and “back” have been locked.

A storage module (not shown in FIG. 1) in the system frame module 112 can be utilized to store the key locking information. The present invention does not limit the storage module to be implemented by a specific form or scheme. In an embodiment, the key locking information can be stored into a storage module outside the system frame module 112. When the key locking information is needed, the system frame module 112 accesses the key locking information from the storage module.

The system frame module 112 compares the key code CODE1 with the key code CODE2. If the key code CODE1 is within the range of the key code CODE2, this indicates that the key clicked by the user is locked. In this situation, the system frame module 112 will intercept the key event, e.g. stop the distribution logic of the key event (i.e. stop transmitting the key event), so that the key operations corresponding to the key event will not be performed. If the key code CODE1 is outside the range of the key code CODE2, this indicates that the key clicked by the user is not locked. In this situation, the system frame module 112 will proceed to perform the distribution logic of the key event, so as to perform the key operations corresponding to the key event. For example, in an embodiment, the key code CODE1 is “3,” and the key code CODE2 is “3” and “4” which indicate that the keys “home” and “back” are both locked. Since “3” is within the range of “3” and “4,” it can be known that the key “home” is already locked, and the key event will therefore not be transmitted. In this way, even if the user clicks the key “home,” the operations corresponding to the key “home” will not be performed. In another embodiment, the key code CODE1 converted from the key event generated by clicking the “search” key is “5,” and the key code CODE2 included in the key locked information is “3” and “4” which indicate that the keys “home” and “back” are both locked. Since “5” is outside the range of “3” and “4,” this represents that the “search” key is not locked. Hence, the key event continues to be transmitted, and the operations corresponding to the “search” key will be performed.

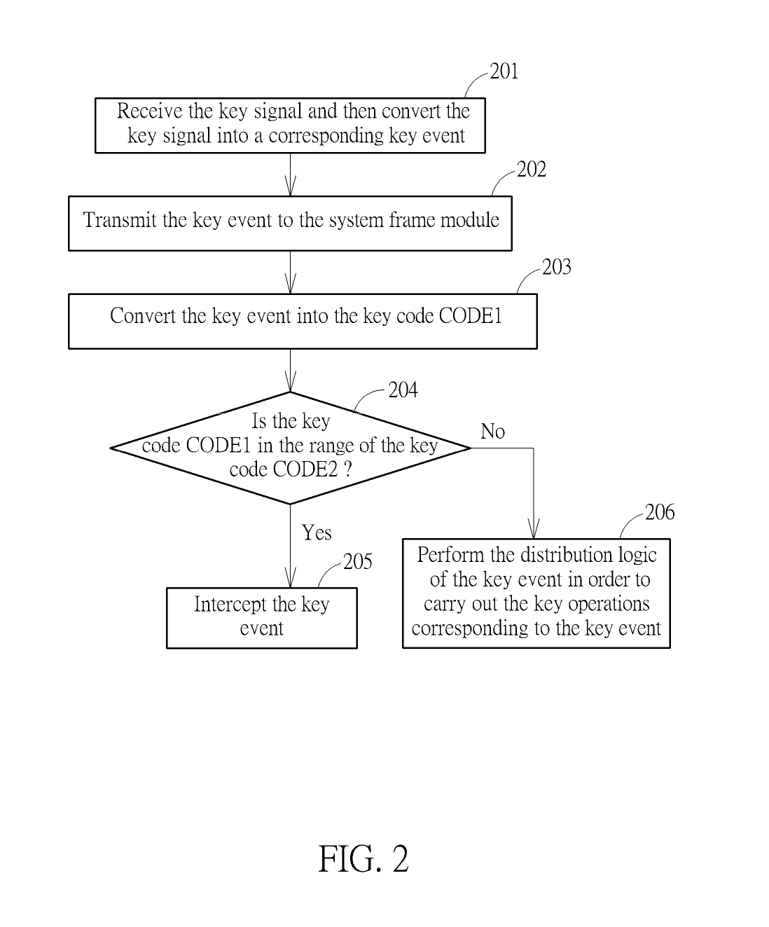

The logic of the key control method performed by the present invention may be represented by a flowchart. Please refer to FIG. 2, which is a flowchart illustrating a method of using a system frame module to control keys according to an embodiment of the present invention. In step 201, the operation of receiving the key signal is performed, and then the operation of converting the key signal into a corresponding key event is performed. In step 202, the key event is transmitted to the system frame module 112. In step 203, the system frame module 112 converts the key event into the key code CODE1, wherein the key code CODE1 corresponds to a physical key or a virtual key of the electronic device 100. In step 204, the system frame module 112 determines whether the key code CODE1 is in the range of the key code CODE2, wherein the key code CODE2 is included in the current key locking information, and the key code CODE2 is arranged for indicating that one or more keys of the electronic device 100 have been locked. If the key code CODE1 is in the range of the key code CODE2, this indicates that the key clicked by the user has been locked. The flow then continues to step 205, to intercept the key event. If the key code CODE1 is not in the range of the key code CODE2, this indicates that the key clicked by the user has not been locked. The flow then continues to step 206, wherein the distribution logic of the key event is performed in order to carry out the key operations corresponding to the key event.

In one embodiment, the user may freely set the keys needed to be locked through the system frame module 112 of the electronic device 100. For example, the electronic device 100 may include a graphic interface 116, and the user may select which keys need to be locked through the graphic interface 116 (i.e. the user self-define key setting). The graphic interface 116 converts the selections made by the user into an arrangement signal S_LOCK which includes a key locking set LCK, wherein the key locking set LCK corresponds to at least one key (e.g. a virtual key or a physical key) of the user input interface 114. In an embodiment, the user can make selections through the graphic interface 116. The present invention is not limited thereto, however. In another embodiment, the user can make selections through voice commands.

The electronic device 100 may further include a key locking arrangement module 118 arranged to receive the arrangement signal S_LOCK transmitted by the graphic interface 116, and record the arrangement signal S_LOCK into an inner database. The key locking arrangement module 118 may convert the key locking set LCK into a key code CODE3, and further obtain key locking information from the system frame module 112. The key locking arrangement module 118 determines whether to update the current key locking information according to whether a current user-defined key arrangement is the same as a previous user-defined key arrangement. Specifically, the key locking arrangement module 118 compares the key code CODE3 with the key code CODE2 included in the key locking information. If the key code CODE3 is equal to the key code CODE2, this indicates that the current user-defined key arrangement is the same as the previous one, and thus the key locking arrangement module 118 ends the arrangements. If the key code CODE3 is not equal to the key code CODE2, this indicates that the current user-defined key arrangement is different from the previous one. Hence, the key locking arrangement module 118 transmits the key code CODE3 to the system frame module 112, and the system frame module 112 replaces the key code CODE2 with the key code CODE3.

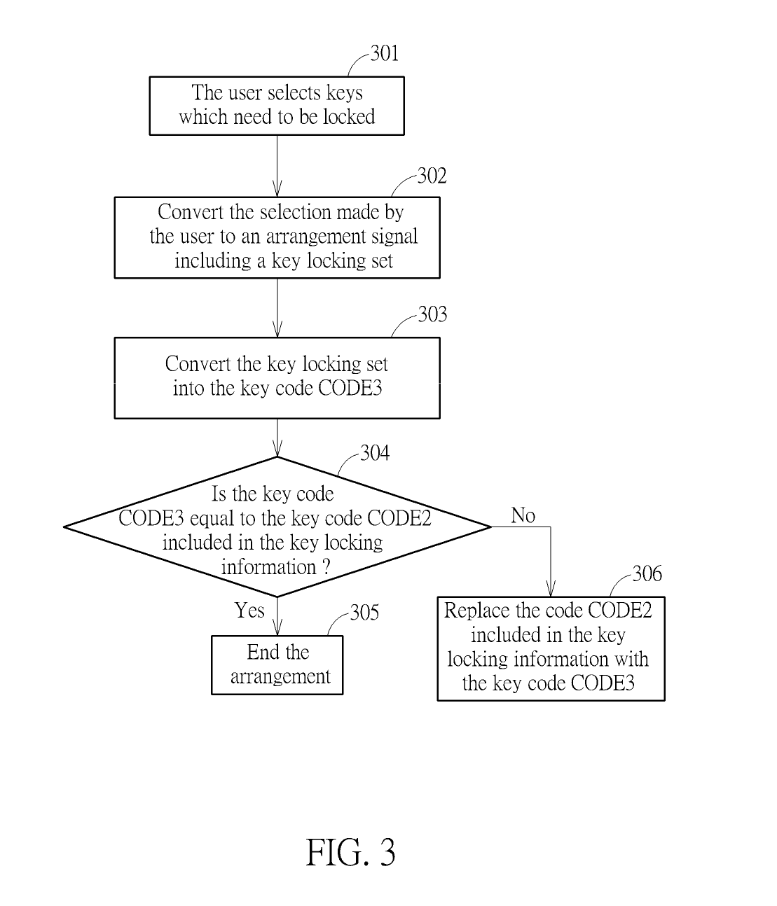

Please refer to FIG. 3, which is a flowchart illustrating a method of selecting keys which need to be locked according to an embodiment of the present invention. In step 301, the user selects keys which need to be locked. In step 302, the selection made by the user is converted to an arrangement signal S_LOCK including a key locking set LCK, wherein the key locking set LCK corresponds to at least one key (e.g. a virtual key or a physical key). In step 303, the key locking set LCK is converted into the key code CODE3. In step 304, the key code CODE3 is compared with the key code CODE2 included in the key locking information, wherein the key locking information may be obtained from the system frame module 112. If the key code CODE3 is equal to the key code CODE2, this indicates that the current user -defined key arrangement is the same as the previous one. The flow then proceeds to step 305, wherein the arrangement is ended. If the key code CODE3 is not equal to the key code CODE2, this indicates that the current user -defined key setting is different from the previous one, the flow then proceeds to step 306, wherein the code CODE2 included in the key locking information is replaced with the key code CODE3.

Please note that the electronic device 100 can be implemented based on various operating systems, such as the IOS system, the Window Phone system and the Android system. Taking the Android system as an example, the system frame module 112 can be implemented through modifying related code logics “PhoneWindowManager.java” and “WindowManager” (e.g. WindowManagerService.java, WindowManage.java and IWindowManager.aidl). For example, a request logic for processing user key locking arrangements can be added into a processing function interceptKeyBeforeQueuing ( ) for intercepting key events of PhoneWindowManager.java. Further, interfaces (e.g., the interface getLockState ( ) for obtaining a key locking state, the interface setLockState ( ) for setting the key locking state, and the interface getLockKeyCodes ( ) for obtaining key codes corresponding to the key locking state) that can be used by the key locking arrangement module 118 and the system frame module 112 can be added into WindowManagerService. The system frame module 112 can use the interface getLockState ( ) through the PhoneWindowManager to obtain the key locking information from the electronic device 100. The system frame module 112 can use the interface getLockKeyCodes ( ) through the PhoneWindowManager to obtain the key code CODE2 included in the key locking information. The key locking arrangement module 118 can use the interface getLockState ( ) to obtain the key locking information of the electronic device 100. The key locking arrangement module 118 can use the interface setLockState ( ) to make the system frame module 112 perform update arrangements upon the key locking information.

In a modification, the present invention can also use the key locking arrangement module 118 to access the hardware driving module 110 to perform key locking arrangements, e.g. directly using the hardware driving module 110 to intercept keys, or modifying both the system frame module 112 and the hardware driving module 110, to make the key locking arrangement module 118 capable of transmitting control signals to the hardware driving module 110 through the system frame module 112. At this point, it is necessary to modify the function logic ioctl of the hardware driving module 110 by adding three corresponding control codes (e.g. the code GET_LOCK_STATE for obtaining the key locking state, the code SET_LOCK_STATE for setting key locking state, and the code GET_LOCK_KEYS for obtaining the interface of key codes corresponding to the key locking state) into the function logic ioctl. The logic for intercepting keys can be implemented in the function handle_input_event of the hardware driving module 110. Please note that the above is merely for illustrative purposes, and not meant to be a limitation of the present invention. According to practical needs, the present invention can put the interception logic in other modules or other system services (or create a self-defined system service) to increase the number of interfaces which can be used by the key locking arrangement module 118 and the system frame module 112, in order to realize the arrangement and updating of the locking states.

In the following, how to directly use the hardware driving module 110 to intercept keys is described in detail. The hardware driving module 110 is used to receive a key signal from the user input interface 114, and then convert the key signal into a key code CODE4, wherein the key code CODE4 corresponds to a physical key or a virtual key of the electronic device 100. The hardware driving module 110 stores the current key locking information of the electronic device 100 in form of a parameter. The parameter can be a global variable, for example. In an embodiment, the key locking information includes a key code CODE5 indicating at least one locked key. The hardware driving module 110 compares the key code CODE4 with the key code CODE5. If the key code CODE4 is within the range of the key code CODE5, this indicates that the key clicked by the user is locked. In this case, the hardware driving module 110 intercepts the key event, so that the key operations corresponding to the key signal will not be performed. If the key code CODE4 is outside the range of the key code CODE5, this indicates that the key clicked by the user is not locked. Hence, the hardware driving module 110 will proceed to perform the key operations corresponding to the key signal. For example, in an embodiment, the key code CODE4 is “3,” and the key code CODE5 is “3” and “4” which indicate that the keys “home” and “back” are both locked. Since “3” is within the range of “3” and “4,” this represents that the key “home” is already locked, and the key signal will be intercepted. In this way, even if the user clicks the key “home,” the operations corresponding to the key “home” will not be performed. In another embodiment, the key code CODE4 converted from the key signal generated by clicking the key “search” is “5,” and the key code CODE5 is “3” and “4” which indicate that the keys “home” and “back” are both locked. Since “5” is outside the range of “3” and “4,” this represents that the key “search” is not locked. In this case, the hardware driving module 110 will proceed to perform the operations corresponding to the key “search”.

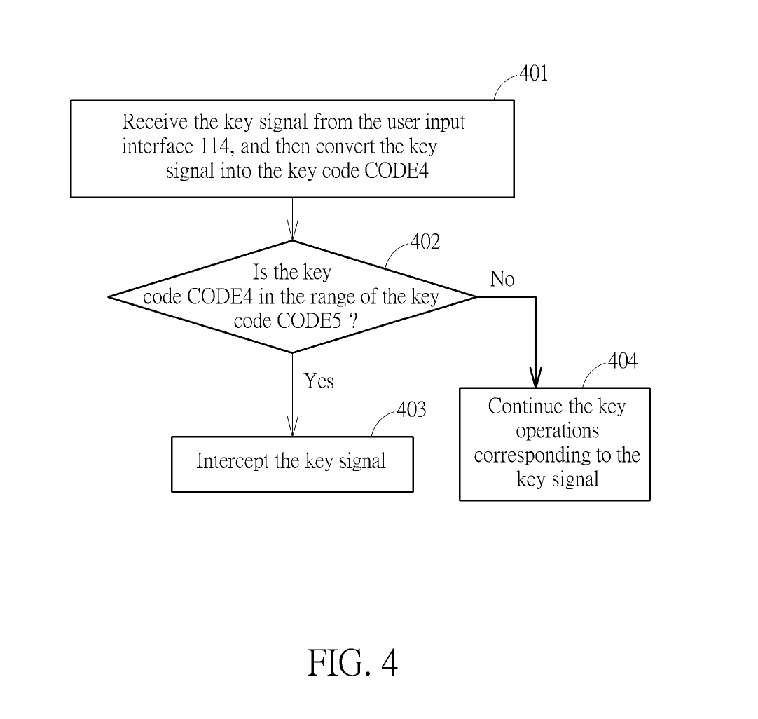

Please refer to FIG. 4, which is a flowchart illustrating a method of using a hardware driving module to intercept keys according to an embodiment of the present invention. In step 401, the hardware driving module 110 receives the key signal from the user input interface 114, and then converts the key signal into the key code CODE4. In step 402, the key code CODE4 is compared with the key code CODES, wherein the current key locking information of the electronic device 100 includes the key code CODE5 indicating at least one locked key. If the key code CODE4 is within the range of the key code CODES, this indicates that the key clicked by the user is locked. The flow then proceeds to step 403. In step 403, the hardware driving module 110 intercepts the key signal. If the key code CODE4 is outside the range of the key code CODE5, this indicates that the key clicked by the user is not locked. The flow then proceeds to step 404. In step 404, the hardware driving module 110 proceeds to perform the key operations corresponding to the key signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A key control method of an electronic device, comprising:
receiving a key event;
obtaining current key locking information of the electronic device from a system frame module of the electronic device; and
determining whether to perform a key operation corresponding to the key event according to the key event and the current key locking information.

2. The key control method of claim 1, wherein the current key locking information comprises a first key code indicating at least one locked key, and the key control method further comprises:
converting the key event into a second key code; and
determining whether to perform the key operation corresponding to the key event according to the first key code and the second key code.

3. The key control method of claim 2, wherein the step of determining whether to perform the key operation corresponding to the key event according to the first key code and the second key code comprises:
when the second key is within a range of the first key code, intercepting the key event and not performing the key operation corresponding to the key event.

4. The key control method of claim 2, wherein the step of determining whether to perform the key operation corresponding to the key event according to the first key code and the second key code comprises:
when the second key is outside a range of the first key code, performing the key operation corresponding to the key event.

5. The key control method of claim 2, wherein the locked key is locked through the system frame module.

6. The key control method of claim 1, wherein the key event is received from a hardware driving module of the electronic device.

7. A key control method of an electronic device, comprising:
receiving a key signal;
obtaining current key locking information of the electronic device from a hardware driving module of the electronic device; and
determining whether to intercept the key signal according to the key signal and the current key locking information.

8. The key control method of claim 7, wherein the current key locking information comprises a first key code indicating at least one locked key, and the key control method further comprises:
converting the key signal into a second key code; and
determining whether to intercept the key signal according to the first key code and the second key code.

9. The key control method of claim 8, wherein the step of determining whether to intercept the key signal according to the first key code and the second key code comprises:
when the second key is within a range of the first key code, intercepting the key signal.

10. The key control method of claim 8, wherein the step of determining whether to intercept the key signal according to the first key code and the second key code comprises:
when the second key is outside a range of the first key code, performing a key operation corresponding to the key signal.

11. An electronic device, comprising:
a hardware driving module, arranged for sending a key event; and
a system frame module, arranged to receive the key event from the hardware driving module, store current key locking information of the electronic device, and determine whether to perform a key operation corresponding to the key event.

12. The electronic device claim 11, wherein the current key locking information comprises a first key code indicating at least one locked key, and the system frame module further converts the key event into a second key code, and determines whether to perform the key operation corresponding to the key event according to the first key code and the second key code.

13. The electronic device claim 12, wherein when the second key is within a range of the first key code, the system frame module intercepts the key event and does not perform the key operation corresponding to the key event.

14. The electronic device claim 12, wherein when the second key is outside a range of the first key code, the system frame module performs the key operation corresponding to the key event.

15. The electronic device claim 12, wherein the locked key is locked through the system frame module.

16. The electronic device claim 10, wherein the locked key is a physical key or a virtual key of the electronic device.

17. An electronic device, comprising:
a user interface, arranged to generate a key signal; and
a hardware driving module, arranged to receive the key signal, store current key locking information of the electronic device, and determine whether to intercept the key signal according to the key signal and the current key locking information.

18. The electronic device claim 17, wherein the current key locking information comprises a first key code indicating at least one locked key, and the hardware driving module is arranged to convert the key signal into a second key code, and determines whether to intercept the key signal according to the first key code and the second key code.

19. The electronic device claim 18, wherein when the second key is within a range of the first key code, the hardware driving module intercepts the key signal.

20. The electronic device claim 18, wherein when the second key is outside a range of the first key code, the hardware driving module performs a key operation corresponding to the key signal.
